(19) United States
(12) Patent Application Publication
(10) Pub. No.: US 2025/0370951 A1
(43) Pub. Date: Dec. 4, 2025

(54) CONFIGURING AND DEBUGGING A DIE-TO-DIE LINK USING A SIDEBAND LINK

(71) Applicant: NVIDIA Corporation, Santa Clara, CA (US)

(72) Inventors: Seema Kumar, Santa Clara, CA (US); Ish Chadha, San Jose, CA (US)

(21) Appl. No.: 18/675,643

(22) Filed: May 28, 2024

(51) Int. Cl. G06F 13/42; G06F 13/40

(52) U.S. Cl. CPC G06F 13/4221; G06F 13/4004

(57) ABSTRACT

A first device includes first circuitry to communicate with a second device over a first die-to-die (D2D) link, second circuitry to communicate with the second device over a second D2D link, and a link controller comprising logic to send first configuration data to the second device over the first D2D link. Responsive to determining that the first configuration data failed to configure the second device, the link controller comprises logic to send second configuration data to the second device over the second D2D link.

### TECHNICAL FIELD

At least one implementation generally pertains to communications systems, and more specifically, but not exclusively, to configuring and/or debugging a die-to-die link using a sideband link.

### BACKGROUND

Data can be processed by multiple coupled integrated circuits (ICs) that may each perform different, sometimes specialized, functions. Often these ICs are colloquially referred to as ‘die,’ with reference to the final stages of the semiconductor manufacturing process where the ICs (e.g., the dies) are cut from a larger semiconductor wafer. Thus, a “die-to-die interconnect” can describe an electrical and data coupling (e.g., interconnect) between at least two distinct ICs (e.g., dies).

### BRIEF DESCRIPTION OF DRAWINGS

Various implementations in accordance with the present disclosure will be described with reference to the drawings, in which:

FIG. 1 is a schematic block diagram of an example die-to-die communications system implementing a sideband link between a primary die and a secondary die, according to one or more aspects of the disclosure.

FIG. 2 is a block diagram illustrating example components of a communication system, in accordance with one or more aspects of the present disclosure.

FIG. 3 is a flow chart of an example method for operating a sideband link, in accordance with one or more aspects of the present disclosure.

FIG. 4 is a block diagram illustrating an exemplary computer system which can be a system with interconnected devices and components, a system-on-a-chip (SOC), or some combination thereof, in accordance with one or more aspects of the present disclosure.

FIG. 5 is a block diagram illustrating an electronic device for utilizing a processor, in accordance with one or more aspects of the present disclosure.

FIG. 6 is a block diagram of a processing system, in accordance with one or more aspects of the present disclosure.

### DETAILED DESCRIPTION

A device package may include two or more dies (also referred to as integrated circuits (IC) or chip) that communicate data via a high-speed link, such as a die-to-die (D2D) interconnect. This die-to-die interconnect can be a high-speed connection that is capable of high bandwidth, low latency, low power and/or high-density data transfers. Each die has a link controller to package data, manage error over the link and configure the link to operate in high-speed.

One of the dies in a package is designated as main or primary. This die may house the main boot agent or the interface for direct access to software (SW). Typically, each die's link controller configures its end of the high-speed link independently and enables the high-speed link. This allows the high-speed link to service the boot process and support configuration command/status for other components of the multi-die system allowing for reduced boot/setup/configuration time. However, configuration requirement of the high-speed die-to-die link itself during setup or boot may need the primary die to send configuration commands or query status from other dies in the package. However, in these systems, the D2D link is the only link available to carry traffic (e.g., data) between the primary and secondary die, including configuration commands and status response. Thus, if the primary die is unable to access configuration data or status from the secondary die (e.g., due to a configuration error), the system loses the ability to debug or troubleshoot operations, particularly of the high-speed die-to-die link itself.

Advantages of the disclosure include, but are not limited to, enabling access to a secondary die when the high-speed link between the link fails to be configured. Advantages of the disclosure further enable a boot agent to receive control and status data from the secondary die, and perform debug or troubleshooting operations to configure the high-speed link and implement workarounds for production mode. Other advantages will be apparent to those skilled in the art of SBD-based transceiver interface design, as will be discussed hereinafter.

Advantages of the disclosure include, but are not limited to, enabling access to a secondary die when a primary die fails to configurate a high-speed link between both dies. Advantages of the disclosure further enable a boot agent to receive control and status data from the secondary die, and perform debug or troubleshooting operations to configure the high-speed link. Other advantages will be apparent to those skilled in the art of SBD-based transceiver interface design, as will be discussed hereinafter.

Implementations of the present disclosure may be discussed with reference to dies and die-to-die interconnects. However, it is noted that implementations of the present disclosure can be used with any type of semiconductor device, such as, for example, chips and chip-to-chip interconnects, integrated circuits (ICs) and IC-to-IC interconnects, and so forth.

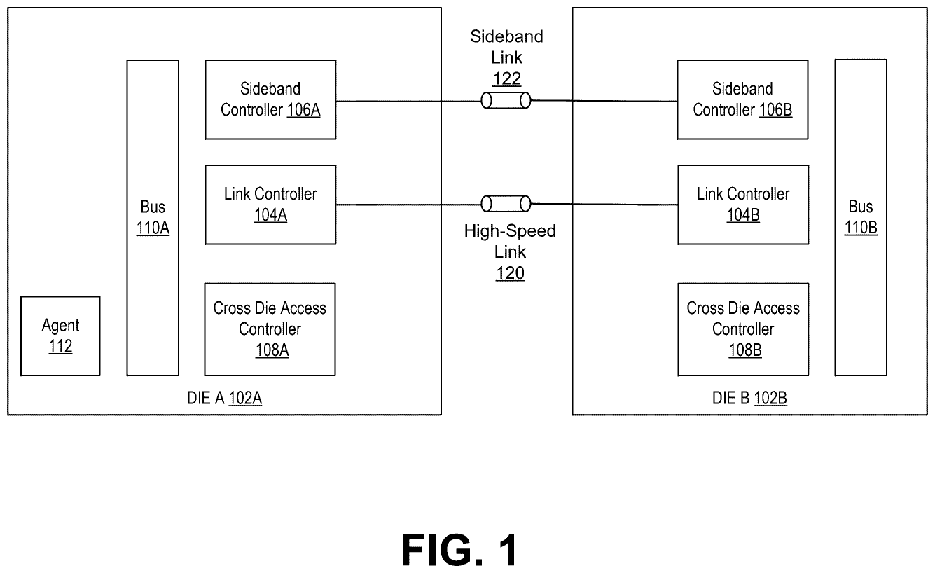

FIG. 1 is a schematic block diagram of an example D2D communications system 100 implementing a sideband link between the primary die (e.g., die A 102A) and a secondary die (e.g., die B 102B) according to various implementations. In some implementations, the system 100 includes a first integrated circuit (IC) chip or die (e.g., die A 102A) and a second IC chip or die (e.g., die B 102B) communicably connected by high-speed link 120 and sideband link 122. Each die 102A, 102B can be a computing or processing device that processes data. For example, die 102A, 102B can be a computer processing unit (CPU), a graphics processing unit (GPU), a data processing unit (DPU), a neural processing unit (NPU), an application-specific integrated circuit (ASIC), a field programmable gate array (FPGA), or the like. These computing devices (e.g., die 102A, 102B) can be implemented as components in devices referred to as machines, computers, servers, network devices, or the like. It is noted that communications system 100 using two dies is by way of illustrative example, and that a primary die can be connected to multiple secondary die. In some implementations, the primary die can be connected to each of the secondary die via a respective high-speed link and respective sideband link. In other implementations, the primary die can be connected to a secondary die via a high-speed link and a sideband link, while the secondary die can be connected to another secondary die via a respective high-speed link and a respective sideband link, or any combination thereof.

Die A 102A can include link controller 104A, sideband controller 106A, cross die access controller 108A, bus 110A, and agent 112. Die B 102B includes link controller 104B, sideband controller 106B, cross die access controller 108B, and bus 110B.

Link controller 104A can communicate with agent 112, cross die access controller 108A, external device (e.g., Peripheral Component Interconnect (PCI) devices, client devices, etc.), memory devices, sideband controller 106A, and die B 102B to perform operations such as training, calibration, link error control, data packetization, reading data, writing data, erasing data, initiating operations (e.g., debug operations), transmitting and receiving data, and other such operations. Link controller 104B can communicate with cross die access controller 108B, memory devices, sideband controller 106B, and die A 102A to perform operations such as training, calibration, link error control, data packetization, reading data, writing data, erasing data, transmitting and receiving data, and other such operations. Link controller 104A, 104B can include hardware such as one or more integrated circuits and/or discrete components, a buffer memory, registers, transceivers (and/or receivers, transmitters, etc.) or a combination thereof. The hardware can include a digital circuitry with dedicated (i.e., hard-coded) logic to perform the operations described herein. Link controller 104A can interface with die B 102B to transmit and receive data over high-speed link 120 and/or sideband link 122. Similarly, link controller 104B can interface with die A 102A to transmit and receive data over high-speed link 120 and/or sideband link 122. Link controller 104A can further include transmitter logic and/or receiver logic (not shown) to facilitate communication with die B 102B, any other component of die A 102A (e.g., sideband controller 106A, cross die access controller 108A, bus 110A, agent 112), or with an external device(s). Link controller 104A can further include transmitter logic and/or receiver logic (not shown) to facilitate communication with die A 102A, any other component of die B 102B (e.g., sideband controller 106B, cross die access controller 108B, bus 110B, etc.).

Cross die access controller 108A, 108B can perform packetization operations, depacketization operations, multiplexing operations (e.g., muxing operations), demultiplexing operations (e.g., demuxing operations), error correcting operations, or any other operations related to processing or preparing data for transmissions and/or to processing received data. Packetization and depacketization operations can refer to the process of encapsulating the data received from the upper layers of system 100 into a packet at the source (e.g., die A 102A) and decapsulating the data from the packet at the destination (e.g., die B 102B). Multiplexing operations can refer to any method of combining multiple signals into a single signal to be transferred over a communication medium (e.g., high-speed link 120 and sideband link 122). In an illustrative example, cross die access controller 108A can perform packetization operations and multiplexing operations to prepare a payload for Die B 102B, transmit the payload to link controller 104A which will transmit the payload to link controller 104B. Link controller 104B can then transmit the payload to cross die access controller 108B for depacketization operations and demultiplexing operations.

Agent 112 can be any software agent, device driver, or computer program configured to react to its environment and run without continuous direct supervision to perform one or more functions related to initializing communication system 100 and/or performing debugging operations. Agent 112 may receive instructions from an external device (e.g., a PCI device, a client device, etc.) and forward the instructions to link controller 104A (or any other component of Die 102A), can initiate a boot process, can initiate a debug process, etc. In some implementations (e.g., during a boot process), agent 112 can instruct link controller 104A to configure high-speed link 120. Configuring high-speed link 120 can include performing one or more operations related to synchronizing, training, calibrating, etc. the transceivers (or receivers and transmitters) related to link controller 104A, 104B. For example, it may be desirable that the data to be communicated from a transmitter of die A 102A to a receiver of die B 102B across high-speed link 120 be in frames of fixed lengths (e.g., each frame may include a same quantity of bits). Thus, configuring the high-speed link 120 can include setting the length of the frames. In some implementations, responsive to a failure in the configuration process, agent 112 can initiate a debug operation (via sideband controllers 106A, 106B and sideband link 122) to determine and correct the issues that occurred during the configuration process. This will be discussed in detail below.

High-speed link 120 can be an electrical link, ground-referenced signaling (GRS) link, radiofrequency (RF) link, optical link, or any other bidirectional (SBD) transceivers capable of performing a two-way communication stream. In some implementations, high-speed link 120 can include one or more RC-dominated channels (an interconnect where small wire dimensions result in high trace resistances) and/or low-attenuation LC transmission lines. In some implementations, high-speed link 120 can be an on-chip link, a link across a substrate (e.g., organic package) or link signaling over a printed circuit board (PCB). High-speed link 120 can transfer data at a relatively higher data transfer rate than sideband link 122

Sideband link 122 can be a robust, slower speed link configured to access control and status data from link controller 104B. The slower speed link can refer to sideband link 122 sending data at a lower data transfer rate than high-speed link 120. The control and status data can include data related to the condition of the high-speed link, the configuration settings of the high-speed link, etc. In some implementations, sideband link 122 includes one data wire (used to transmit data) and one clock wire (used to transmit a pulse to instruct component to perform a step) for communication from die A 102A to die B 102B (e.g., from sideband controller 106A to sideband controller 106B), and one data wire and one clock wire for communication from die B 102A to die A 102B (e.g., sideband controller 106B to sideband controller 106A). In some implementations, the data sent over sideband link 122 can be transmitted using a slower speed than data transmitted over high-speed link 120. In some implementations, sideband link 122 may require relatively little to no dependency on configuration for symbol or data alignment, frame size setting, etc.

Sideband controller 106A, 106B can be used to read status data and change configuration settings related to link controller 104B and/or high-speed link 120. In particular, in response to a failure in the calibration process of high-speed link 120, sideband controller 106A can request, via sideband link 122 and sideband controller 106B, status data from link controller 104B. A request can refer to computer instructions, a memory access command (e.g., a read command, a write command, an erase command, etc.), etc. Once received, sideband controller 106A can forward the status data to agent 112 (or an external device), which can perform debugging operations (e.g., generate a patch to be sent over high-speed link 120 and/or sideband link 122). A patch is a set of changes to software and/or hardware designed to update, fix, or improve the functionality of the software and/or hardware.

Bus 110A, 110B can be a communication system that connects the components of a communication system 100. For example, bus 110A, 110B can carry data, determine where the data should be sent to or read from, and determine an operation to perform, etc.

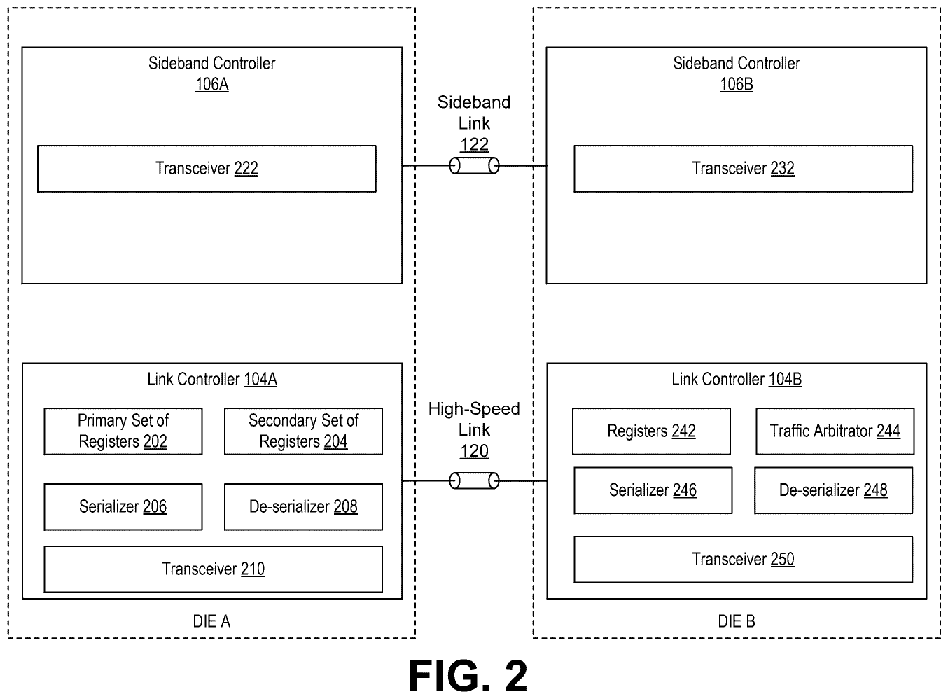

FIG. 2 is a block diagram illustrating example components of communication system 200, in accordance with one or more aspects of the present disclosure. In some implementations, the communication system 200 can be the same as, or similar to the communication device 100 of FIG. 1. In the example shown, communication system 200 can include link controller 104A, 104B, sideband controller 106A, 106B, high-speed link 120, and sideband link 122.

Link controller 104A can include a primary set of registers 202, a secondary set of registers 204, serializer 206, de-serializer 208, and transceiver 210. Registers 202, 204 can be any type of computer registers used to store values or instructions, such as, for example, data registers, address registers, general purpose registers, special-purpose registers, status registers, internal registers, or any other type of register. The primary set of registers can be used to control and/or read data on die B 102B via high-speed link 120, perform flow control (e.g., start a transaction and poll to check when read data is valid), etc. The secondary set of registers 204 can be used to control and/or read data on die B 102B via sideband link 122, perform flow control (e.g., start a transaction and poll to check when read data is valid), etc. The secondary set of registers can be reserved (e.g., only used) for sending and/or receiving data via sideband link 122. For example, in response to data being store on secondary set of registers 204, sideband controller 106A can initiate operations to transfer the data to die B 102B via sideband link 122. Serializer 206 can be configured to serialize transactions to die B 102B using a pre-determined sequence. De-serializer 208 can be configured to deserialize transactions from die B 102B using a pre-determined sequence. Serialization can refer to the process of translating data structure or object state into a format that can be stored or transmitted (e.g., data streams) and reconstructed (deserialized) at a destination (e.g., die B 102B). An example sequence can include a memory address followed by read and/or write transaction followed by write data. De-serializer 208 can deserialize the response and expose the response to the primary set of registers 202. Serializer 206 can also indicate when a transaction is complete. Transceiver 210 can be any device (e.g., a transceiver, a transmitter, a receiver, etc.) used to transmit and or receive data via high-speed link 120.

Sideband controller 106A can include transceiver 222. Transceiver 212 can be any device (e.g., a transceiver, a transmitter, a receiver, etc.) used to transmit and or receive data via sideband link 122. In some implementations, transceiver 212 can be configured to transmit the serialized data, via sideband link 122, from the secondary set of registers 204 to sideband controller 106B of Die B 102B. In some implementations, to aid in transaction framing, a single pulse or reverse polarity can be sent to sideband controller 106B to indicate the start of a transaction. The length of the transaction can remain constant for read or write operations with design simplicity or kept variable based on the read and or write operations.

Sideband controller 106B can also include a include a transceiver (e.g., transceiver 232). Transceiver 232 can be configured to receive a serialized transaction from sideband controller 106A and retime the transaction to the local (slower) clock used by sideband controller 106B. Transceiver 232 can forward the transaction to link controller 104B, receive a response from link controller 104B (e.g., control data, status data, etc.) and forward the response to sideband controller 106A via sideband link 122.

Link controller 104B can include registers 242, traffic arbitrator 244, serializer 246, de-serializer 248, and transceiver 250. De-serializer 248 can be configured to de-serialize the received transaction request from die A 102A. The transaction request can be stored on registers 242. It is noted that requests received via high-speed link as well as requests received via sideband link 122 can be stored on registers 242. Serializer 246 can be configured to serialize transactions (e.g., responses such as control data, status data, etc.) back to die A 102A using a pre-determined sequence. Transceiver 250 can be configured to send and receive data over high-speed link 120.

Traffic arbitrator 244 can process requests received from link controller 104A and from sideband controller 106A. In some implementations, traffic arbiter 244 can the requests using one or more schemes. For example, traffic arbiter 244 can process the requests using a round-robin scheme (process requests from one controller then the other), a priority scheme (e.g., requests received via the high-speed link 120 can be high priority request and process prior to request received via sideband link 122, which can be low priority requests), a first-in-first-out (FIFO) scheme, and so forth.

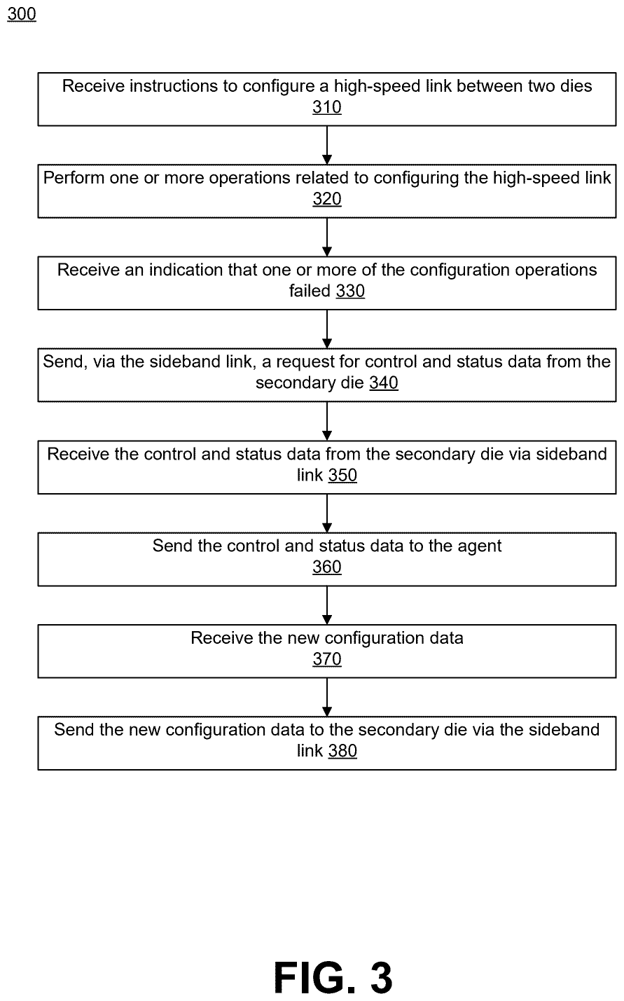

FIG. 3 is a flow chart of an example method 300 for operating a sideband link according to some implementations. The method 300 can be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an example, method 300 can be performed by link controller 104A of FIG. 1.

Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 310, processing logic receives instructions to configure a high-speed link between two dies. For example, processing logic can receive instructions to configure high-speed link 120 so that die A 102A can communicate with die B 102B. The instructions can include configuration data related to synchronizing, training, and/or calibrating transceiver 210 and/or transceiver 250. In some implementations, the instructions can be received from agent 112, or from an external entity. In some implementations, the instructions can be received during a boot process of a communications system (e.g., communications system 100).

At operation 320, processing logic performs one or more operations related to configuring high-speed link 120. For example, the processing logic can send, via high-speed link 120, configuration data instructing die B 102B to transmit data via high-speed link 120 using frames of a particular fixed length. The configuration data can be sent to a particular set of registers (e.g., registers 242) related to link controller 104B.

At operation 330, processing logic receives an indication that one or more of the configuration operations failed. For example, the processing logic can request status data from die B 102B, and receive an indication that the high-speed link 120 has not been established. In some implementations, the indication that the high-speed link 120 has not been established can be due to the configuration data failing to configurate high-speed link 120, the processing logic failing to send the configuration data to the secondary die, the secondary die failing to process the configuration data, etc.

At operation 340, processing logic sends, via sideband link 122, a request for control and status data from the secondary die (e.g., die B 102B). In some implementations, the processing logic can store the instructions in a set of registers (e.g., secondary set of registers 204) that are exposed to a controller (e.g., sideband controller 106A) related to sideband link 122.

At operation 350, processing logic receives the control and status data from the secondary die via sideband link 122. In some implementations, the control and status data can indicate the current configuration settings of high-speed link 120 and/or link controller 104B.

At operation 360, processing logic sends the control and status data to agent 112. In some implementations, the processing logic (and/or agent 112) can send the control and status data to an external entity. Agent 112 (and/or the external entity) can use the control and status data to generate a new configuration data for configuring high-speed link 120.

At operation 370, processing logic receives the new configuration data. The new configuration data can include correction data configured to correct or debug the issues that prevented high-speed link 120 from being configured. In some implementations, the processing logic can also receive instructions indicate whether to send the new configuration data to die B via sideband link 122.

At operation 380, processing logic sends the new configuration data to the secondary die via sideband link 122. The new configuration data can be sent to registers 242. The secondary die (e.g., die B 102B) can use the new configuration data to configure high-speed link 120. Once configured, die A 102A and die B 102B can communicate via high-speed link 120. It is noted that sideband link 122 can also be used for other communications between die A 102A and die B 102B, such as, for example, when high-speed link 120 is in sleep mode, when sending a low priority instruction, etc.

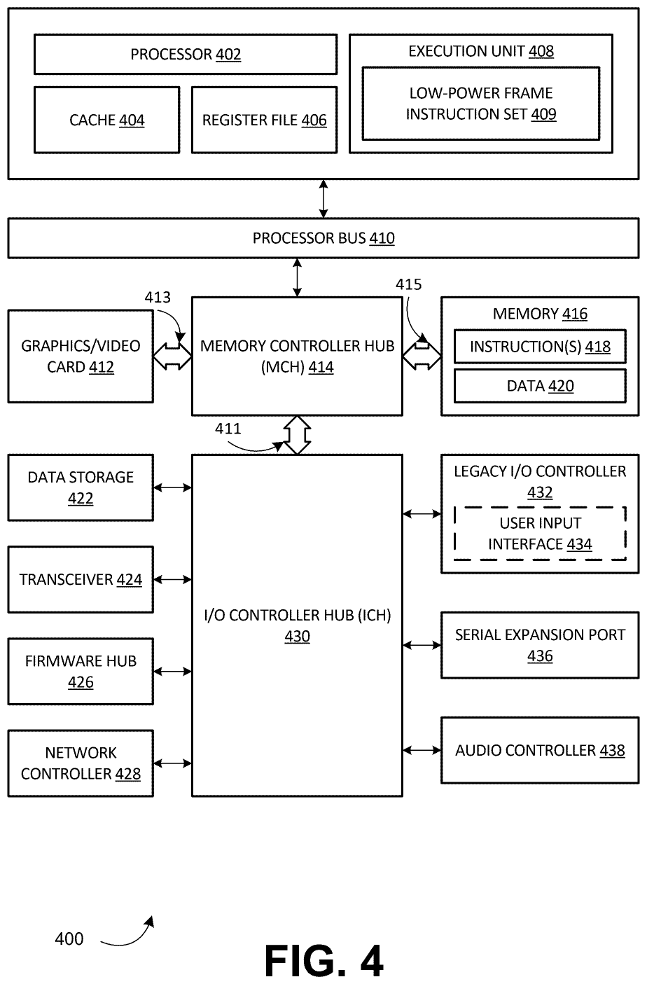

FIG. 4 is a block diagram illustrating an exemplary computer system, such as computer system 400, which can be a system with interconnected devices and components, a system-on-a-chip (SOC), or some combination thereof, according to aspects of the disclosure. In some implementations, computer system 400 can include, without limitation, a component, such as a processor 402 (e.g., a processing device), to employ execution units including logic to perform algorithms for process data, in accordance with the present disclosure, such as in the implementations described herein. In some implementations, computer system 400 can include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In some implementations, computer system 400 can execute a version of WINDOWS' operating system available from Microsoft Corporation of Redmond, Wash., although other operating systems (UNIX and Linux, for example), embedded software, and/or graphical user interfaces, can also be used.

Implementations can be used in other devices such as handheld devices and embedded applications. Some examples of handheld devices include cellular phones, Internet Protocol devices, digital cameras, personal digital assistants (PDAs), and handheld PCs. In some implementations, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one implementation.

In some implementations, computer system 400 can include, without limitation, processor 402 that can include, without limitation, one or more execution units 408 to perform operations according to techniques described herein. In some implementations, computer system 400 is a single-processor desktop or server system, but in another implementation, the computer system 400 can be a multiprocessor system. In some implementations, processor 402 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In some implementations, processor 402 can be coupled to a processor bus 410 that can transmit data signals between processor 402 and other components in computer system 400.

In some implementations, processor 402 can include, without limitation, a Level 1 (L1) internal cache memory (cache) cache 404. In some implementations, processor 402 can have a single internal cache or multiple levels of internal cache. In some implementations, the cache memory can reside external to processor 402. Other implementations can also include a combination of both internal and external caches depending on particular implementation and needs. In some implementations, register file 406 can store different types of data in various registers, including and without limitation, integer registers, floating-point registers, status registers, and instruction pointer registers.

In some implementations, an execution unit 408, including and without limitation, logic to perform integer and floating-point operations, also reside in processor 402. In some implementations, processor 402 can also include a microcode (μcode) read-only memory (ROM) that stores microcode for certain macro instructions. In some implementations, execution unit 408 can include logic to handle a low-power frame instruction set 409. In some implementations, by including low-power frame instruction set 409 in an instruction set of a general-purpose processor, such as processor 402, along with associated circuitry to execute instructions, operations used by many multimedia applications can be performed using packed data in a general-purpose processor, such as processor 402. In one or more implementations, many multimedia applications can be accelerated and executed more efficiently by using the full width of a processor's data bus for performing operations on packed data, which can eliminate the need to transfer smaller units of data across the processor's data bus to perform one or more operations one data element at a time.

In some implementations, execution unit 408 can also be used in microcontrollers, embedded processors, graphics devices, DSPs, and other types of logic circuits. In some implementations, computer system 400 can include, without limitation, a memory 416. In some implementations, memory 416 can be implemented as a Dynamic Random Access Memory (DRAM) device, a Static Random Access Memory (SRAM) device, a flash memory device, or other memory devices. In some implementations, memory 416 can store instruction(s) 418 and/or data 420 represented by data signals that can be executed by processor 402, which is operatively coupled to memory 416.

In some implementations, the system logic chip can be coupled to processor bus 410 and memory 416. In some implementations, the system logic chip can include, without limitation, a memory controller hub (MCH), such as MCH 414, and processor 402 can communicate with MCH 414 via processor bus 410. In some implementations, MCH 414 can provide a high bandwidth memory path 415 to memory 416 for instruction and data storage and for storage of graphics commands, data, and textures. In some implementations, MCH 414 can direct data signals between processor 402, memory 416, and other components in computer system 400 and bridge data signals between processor bus 410, memory 416, and a system input/output (I/O) 411. In some implementations, a system logic chip can provide a graphics port for coupling to a graphics controller. In some implementations, MCH 414 can be coupled to memory 416 through a high bandwidth memory path 415, and graphics/video card 412 can be coupled to MCH 414 through an Accelerated Graphics Port (AGP) interconnect 413.

In some implementations, computer system 400 can use the system I/O 411 that is a proprietary hub interface bus to couple the MCH 414 to I/O controller hub (ICH), such as ICH 430. In some implementations, ICH 430 can provide direct connections to some I/O devices via a local I/O bus. In some implementations, a local I/O bus can include, without limitation, a high-speed I/O bus for connecting peripherals to memory 416, chipset, and processor 402. Examples can include, without limitation, data storage 422, a transceiver 424, a firmware hub (flash Basic Input/Output System (BIOS)) 426, a network controller 428, a legacy I/O controller 432 containing a user input interface 434, a serial expansion port 436, such as Universal Serial Bus (USB), and an audio controller 438. In some implementations, data storage 422 can include a hard disk drive, a floppy disk drive, a compact disc read-only memory (CD-ROM) device, a flash memory device, or other mass storage devices.

In some implementations, FIG. 4 illustrates a computer system 400, which includes interconnected hardware devices or “chips,” whereas, in other implementations, FIG. 4 can illustrate an exemplary System on a Chip (SoC). In some implementations, devices can be interconnected with proprietary interconnects, standardized interconnects (e.g., Peripheral Component Interconnect buses (e.g., PCI, PCI Express)), or some combination thereof. In some implementations, one or more components of computer system 400 are interconnected using compute express link (CXL) interconnects.

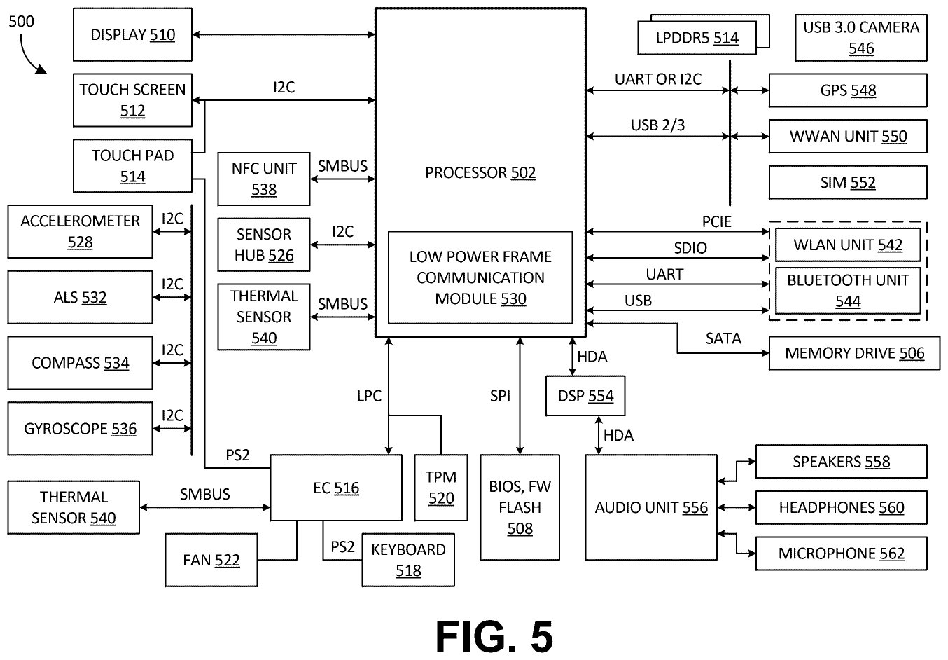

FIG. 5 is a block diagram illustrating an electronic device 500 for utilizing a processor 502, according to aspects of the disclosure. In some implementations, electronic device 500 can be, for example, and without limitation, a notebook, a tower server, a rack server, a blade server, a laptop, a desktop, a tablet, a mobile device, a phone, an embedded computer, or any other suitable electronic device.

In some implementations, electronic device 500 can include, without limitation, processor 502 communicatively coupled to any suitable number or kind of components, peripherals, modules, or devices. In some implementations, processor 502 coupled using a bus or interface, such as an Inter-Integrated Circuit (I2C) bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen1/3.1 Gen2, and USB4), or a Universal Asynchronous Receiver/Transmitter (UART) bus. In some implementations, FIG. 5 illustrates a system, which includes interconnected hardware devices or “chips,” whereas in other implementations, FIG. 5 can illustrate an exemplary System on a Chip (SoC). In some implementations, devices illustrated in FIG. 5 can be interconnected with proprietary interconnects, standardized interconnects (e.g., Peripheral Component Interconnect Express (PCIe)), or some combination thereof. In some implementations, one or more components of FIG. 5 are interconnected using compute express link (CXL) interconnects.

In some implementations, FIG. 5 can include a display 510, a touch screen 512, a touch pad 514, a Near Field Communications unit (NFC) 538, a sensor hub 526, a thermal sensor 540, an Express Chipset (EC), such as EC 516, a Trusted Platform Module (TPM), such as TPM 520, BIOS/firmware (FW)/flash memory, such as BIOS, FW Flash 508, a DSP 554, a memory drive 506 such as a Solid State Disk (SSD) or a Hard Disk Drive (HDD), a wireless local area network unit (WLAN), such as WLAN unit 542, a Bluetooth unit 544, a Wireless Wide Area Network unit (WWAN), such as WWAN unit 550, a Global Positioning System (GPS) 548, a camera (USB 3.0 camera) 546, such as a USB 3.0 camera, and/or a Low Network bandwidth Double Data Rate (LPDDR) memory unit, such as LPDDR5 504 implemented in, for example, LPDDR5 standard. These components can each be implemented in any suitable manner.

In some implementations, other components can be communicatively coupled to processor 502 through the components discussed above. In some implementations, processor 502 can include a low-power frame transmission module 530. In some implementations, an accelerometer 528, Ambient Light Sensor (ALS), such as ALS 532, compass 534, and a gyroscope 536 can be communicatively coupled to sensor hub 526. In some implementations, thermal sensor 540, a fan 522, a keyboard 518, and a touch pad 514 can be communicatively coupled to EC 516. In some implementations, speakers 558, headphones 560, and microphone 562 can be communicatively coupled to an audio unit 556 which can, in turn, be communicatively coupled to DSP 554. In some implementations, audio unit 556 can include, for example, and without limitation, an audio coder/decoder (codec) and a class-D amplifier. In some implementations, a subscriber identification module (SIM) card, such as SIM 552 can be communicatively coupled to WWAN unit 550. In some implementations, components such as WLAN unit 542 and Bluetooth unit 544, as well as WWAN unit 550 can be implemented in a Next Generation Form Factor (NGFF).

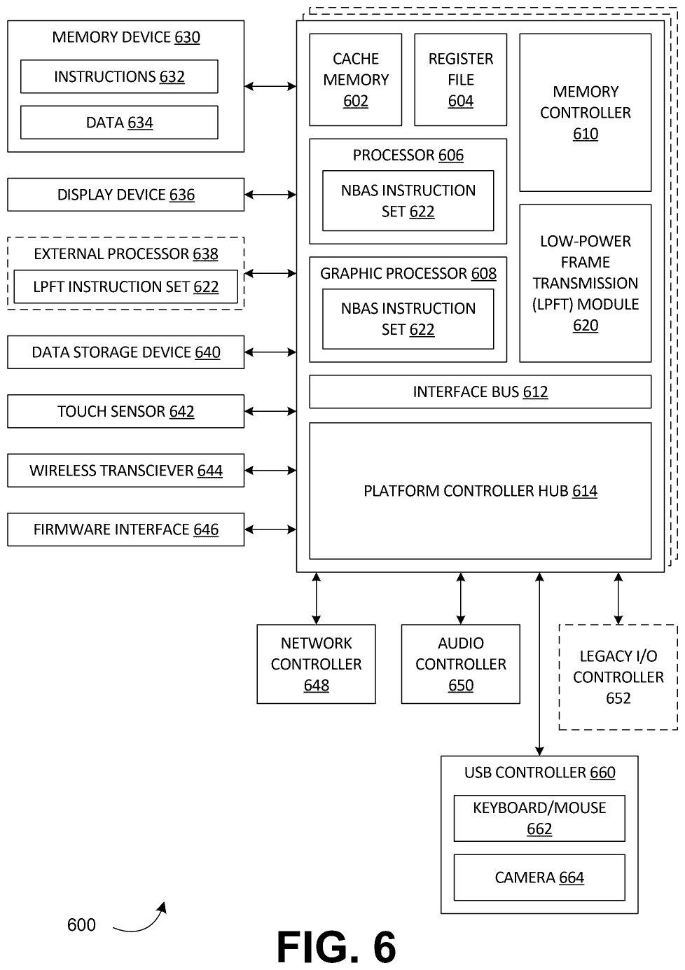

FIG. 6 is a block diagram of a processing system 600, according to aspects of the disclosure. In some implementations, the processing system 600 includes cache memory 602, register file 604, processors 606, graphics processors 608, memory controller 610, interface bus 612, platform controller hub 614, and low-power frame transmission module 620. Processing system 600 can be a single processor desktop system, a multiprocessor workstation system, or a server system having a large number of processors 606 or graphics processors 608. In some implementations, the processing system 600 is a processing platform incorporated within a system-on-a-chip (SoC) integrated circuit for use in mobile, handheld, or embedded devices.

In some implementations, the processing system 600 can include, or be incorporated within a server-based gaming platform, a game console, including a game and media console, a mobile gaming console, a handheld game console, or an online game console. In some implementations, the processing system 600 is a mobile phone, smart phone, tablet computing device, or mobile Internet device. In some implementations, the processing system 600 can also include, couple with, or be integrated within, a wearable device, such as a smart watch wearable device, smart eyewear device, augmented reality device, or virtual reality device. In some implementations, the processing system 600 is a television or set-top box device having one or more processors 606 and a graphical interface generated by one or more graphics processors 608.

In some implementations, one or more processors 606 each include one or more of the processor cores to process instructions which, when executed, perform operations for system and user software. In some implementations, one or more processors 606 and/or one or more graphics processors can be configured to process a portion of the low-power frame transmission (LPFT) instruction set, such as LPFT instruction set 622. In some implementations, LPFT instruction set 622 can facilitate Complex Instruction Set Computing (CISC), Reduced Instruction Set Computing (RISC), or computing via a Very Long Instruction Word (VLIW). In some implementations, processor cores can each process a different instruction set from LPFT instruction set 622, which can include instructions to facilitate emulation of other instruction sets (not illustrated). In some implementations, processor cores can also include other processing devices, such as a Digital Signal Processor (DSP).

In some implementations, processors 606 includes cache memory 602. In some implementations, processors 606 can have a single internal cache or multiple levels of internal cache. In some implementations, cache memory 602 is shared among various components of processors 606. In some implementations, processors 606 also uses an external cache (e.g., a Level 3 (L3) cache or Last Level Cache (LLC)) (not illustrated), which can be shared among processor cores using known cache coherency techniques. In some implementations, register file 604 is additionally included in processors 606, which can include different types of registers for storing different types of data (e.g., integer registers, floating-point registers, status registers, and an instruction pointer register). In some implementations, register file 604 can include general-purpose registers or other registers.

In some implementations, one or more processors 606 are coupled with one or more interface bus 612 to transmit communication signals such as address, data, or control signals between processor cores and other components in processing system 600. In some implementations, interface bus 612, in one implementation, can be a processor bus, such as a version of a Direct Media Interface (DMI) bus. In some implementations, interface bus 612 is not limited to a DMI bus, and can include one or more PCI buses (e.g., PCI, PCI Express), memory busses, or other types of interface busses. In some implementations, processors 606 include an integrated memory controller (e.g., memory controller 610) and a platform controller hub 614 (PCH). In some implementations, memory controller 610 facilitates communication between a memory device and other components of the processing system 600, while platform controller hub 614 provides connections to I/O devices via a local I/O bus.

In some implementations, the memory device 630 can be a dynamic random-access memory (DRAM) device, a static random-access memory (SRAM) device, a flash memory device, a phase-change memory device, or some other memory device having suitable performance to serve as process memory. In some implementations, the memory device 630 can operate as system memory for processing system 600 to store instructions 632 and data 634 for use when one or more processors 606 executes an application or process. In some implementations, memory controller 610 also optionally couples with an external processor 638, which can communicate with one or more graphics processors 608 in processors 606 to perform graphics and media operations. In some implementations, a display device 636 can connect to processors 606. In some implementations, the display device 636 can include one or more of an internal display device, as in a mobile electronic device or a laptop device, or an external display device attached via a display interface (e.g., DisplayPort, etc.). In some implementations, display device 636 can include a head-mounted display (HMD) such as a stereoscopic display device for use in virtual reality (VR) applications or augmented reality (AR) applications.

In some implementations, the platform controller hub 614 enables peripherals to connect to memory device 630 and processors 606 via a high-speed I/O bus. In some implementations, I/O peripherals include, but are not limited to, a data storage device 640 (e.g., hard disk drive, flash memory, etc.), a touch sensor 642, a wireless transceiver 644, firmware interface 646, a network controller 648, or an audio controller 650.

In some implementations, the data storage device 640 can connect via a storage interface (e.g., SATA) or via a peripheral bus, such as a PCI bus (e.g., PCI, PCI Express). In some implementations, touch sensor 642 can include touch screen sensors, pressure sensors, or fingerprint sensors. In some implementations, wireless transceiver 644 can be a Wi-Fi transceiver, a Bluetooth transceiver, or a mobile network transceiver such as a 3G, 4G, Long Term Evolution (LTE), 5G, or 6G transceiver. In some implementations, firmware interface 646 enables communication with system firmware and can be, for example, a unified extensible firmware interface (UEFI). In some implementations, the network controller 648 can enable a network connection to a wired network. In some implementations, a high-performance network controller (not illustrated) couples with interface bus 612. In some implementations, audio controller 650 can be a multi-channel high-definition audio controller. In some implementations, the processing system 600 includes an optional legacy I/O controller 652 for coupling legacy (e.g., Personal System-2 (PS/2)) devices to the processing system 600. In some implementations, the platform controller hub 614 can also connect to one or more Universal Serial Bus (USB) controllers, such as USB controller 660 to connect input devices, such as a keyboard and mouse combination (keyboard/mouse 662), a camera 664, or other USB input devices.

In some implementations, an instance of memory controller 610 and platform controller hub 614 can be integrated into a discreet external graphics processor, such as external processor 638. In some implementations, the platform controller hub 614 and/or memory controller 610 can be external to one or more processors 606. For example, in some implementations, the processing system 600 can include an external memory controller (e.g., memory controller 610) and the platform controller hub 614, which can be configured as a memory controller hub and peripheral controller hub within a system chipset that is in communication with the processors 606.

Other variations are within the spirit of the present disclosure. Thus, while disclosed techniques are susceptible to various modifications and alternative constructions, certain illustrated implementations thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed implementations (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain implementations require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some implementations, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some implementations, code is stored on a computer-readable storage medium, for example, in form of a computer program comprising a plurality of instructions executable by one or more processors. In some implementations, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some implementations, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some implementations, comprises multiple non-transitory computer-readable storage media and one or more of individual non-transitory storage media of multiple non-transitory computer-readable storage media lacks all of the code while multiple non-transitory computer-readable storage media collectively store all of the code. In some implementations, executable instructions are executed such that different instructions are executed by different processors-for example, a non-transitory computer-readable storage medium stores instructions, and a main central processing unit (CPU) executes some of the instructions while a graphics processing unit (GPU) executes other instructions. In some implementations, different components of a computer system have separate processors, and different processors execute different subsets of instructions.

Accordingly, in some implementations, computer systems are configured to implement one or more services that singly or collectively perform operations of processes described herein, and such computer systems are configured with applicable hardware and/or software that enable the performance of operations. Further, a computer system that implements at least one implementation of present disclosure is a single device and, in another implementation, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate implementations of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A first device comprising:
a first link controller configured to communicate, over a first die-to-die (D2D) link, with a second link controller of a second device and;
a first sideband controller configured to communicate, over a second D2D link, with a second sideband controller of the second device, wherein the first link controller comprises logic to:
send first configuration data to the second device over the first D2D link; and
responsive to determining that the first configuration data failed to configure the second device, send second configuration data to the second device over the second D2D link.

2. The first device of claim 1, wherein the first D2D link is configured to transmit data at a higher data transfer rate than the second D2D link.

3. The first device of claim 1, wherein the second D2D link comprises a pair of data wires and a pair of clock wires.

4. The first device of claim 1, wherein the second configuration data comprises correction data to enable the second device to restore communication with the first device over the first D2D link.

5. The first device of claim 1, further comprising:
a set of registers reserved for sending data via the second D2D link.

6. The first device of claim 1, wherein the first configuration data is sent from a first set of registers of the first device to a second set of registers of the second device and the second configuration data is sent from a third set of registers of the first device to the second set of registers.

7. The first device of claim 1, wherein the logic is further to:
receive, via the second D2D link, control and status data from the second device.

8. A method, comprising:
sending, from a first link controller of a first device, first configuration data to a second link controller associated with a second device over a first die-to-die (D2D) link; and
responsive to determining that the first configuration data failed to configure the second device, sending, from a first sideband controller of the first device, second configuration data to a second sideband controller of the second device over a second D2D link.

9. The method of claim 8, wherein the first D2D link is configured to transmit data at a higher data transfer rate than the second D2D link.

10. The method of claim 8, wherein the second D2D link comprises a pair of data wires and a pair of clock wires.

11. The method of claim 8, wherein the second configuration data comprises correction data to enable the second device to restore communication with the first device over the first D2D link.

12. The method of claim 8, wherein the second configuration data is sent using a set of registers reserved for sending data via the second D2D link.

13. The method of claim 8, wherein the first configuration data is sent from a first set of registers of the first device to a second set of registers of the second device and the second configuration data is sent from a third set of registers of the first device to the second set of registers.

14. The method of claim 8, further comprising:
receiving, via the second D2D link, control and status data from the second device.

15. A non-transitory computer-readable storage medium comprising instructions that, when executed by a processing device operatively coupled to a memory, performs operations comprising:
sending, from a first link controller of a first device, first configuration data to a second link controller of a second device over a first die-to-die (D2D) link; and
responsive to determining that the first configuration data failed to configure the second device, sending, from a first sideband controller of the first device, second configuration data to a second sideband controller of the second device over a second D2D link.

16. The non-transitory computer-readable storage medium of claim 15, wherein the first D2D link is configured to transmit data at a higher data transfer rate than the second D2D link.

17. The non-transitory computer-readable storage medium of claim 15, wherein the second D2D link comprises a pair of data wires and a pair of clock wires.

18. The non-transitory computer-readable storage medium of claim 15, wherein the second configuration data comprises correction data to enable the second device to restore communication with the first device over the first D2D link.

19. The non-transitory computer-readable storage medium of claim 15, wherein the second configuration data is sent using a set of registers reserved for sending data via the second D2D link.

20. The non-transitory computer-readable storage medium of claim 15, wherein the first configuration data is sent from a first set of registers of the first device to a second set of registers of the second device and the second configuration data is sent from a third set of registers of the first device to the second set of registers.
